(19) United States
(12) Patent Application Publication
(10) Pub. No.: US 2016/0047571 A1
(43) Pub. Date: Feb. 18, 2016

(54) SUPPORT STAND FOR EXPANSION TANK

(71) Applicants: Christopher D. Jones, Rosedale, MD (US); James L. DeRuchie, Middle River, MD (US); Glenn M. Eichner, Kingsville, MD (US)

(72) Inventors: Christopher D. Jones, Rosedale, MD (US); James L. DeRuchie, Middle River, MD (US); Glenn M. Eichner, Kingsville, MD (US)

(21) Appl. No.: 14/458,238

(22) Filed: Aug. 12, 2014

(51) Int. Cl. F24H 9/06; F16M 13/02

(52) U.S. Cl. CPC F24H 9/06; F16M 13/02

(57) ABSTRACT

The invention provides a support stand for an expansion tank that is mounted directly atop a hot water heater system.

### CLAIM OF PRIORITY

This patent application claims priority under 35 USC 119 (e) (1) from U.S. Provisional Patent Application Ser. No. 61/864,661 filed Aug. 12, 2013, of Christopher Jones and James Deuchie entitled, “Support Stand.”

### BACKGROUND OF THE INVENTION

1. Field of the Invention

This invention relates generally to a support stand and, more particularly, the invention relates to a support stand for expansion tanks that is mounted directly atop the hot water heater system, as opposed to suspended from the rafters.

2. Description of the Prior Art

A common plumbing accessory found in virtually every home with running water is a hot water heater. While some newer homes are equipped with “on demand” water heating systems, standard, free standing water heaters are far more commonplace and are found in the majority of US homes. Essentially, a hot water heater is a drum filled with water and comprising a heating mechanism mounted either to the base of the heater or on the interior of the unit. As thermal expansions occur as the water is heated, an expansion tank is utilized in order to prevent pressure increases in the system. Extremely important, these tanks are required in many areas as a result of newer and more stringent construction codes. Water that is heated 70 degrees will expand approximately 2 percent. For those who have closed water systems that prevent water from flowing back into the water main, this expansion can result in a rapid pressure increase within the plumbing system, often times resulting in pipes leaking or bursting. The expansion tank accommodates this water expansion, allowing this pressure to be released without damaging the heater's external plumbing. Most professional plumbers recommend that expansion tanks be installed on the cold water line and positioned downstream of the actual shutoff valve. Older model expansion tanks are typically mounted horizontally, while new, smaller models can be installed vertically or at an angle. In the case of the former, these tanks are often strapped to rafters directly above the water heater in order to support the weight of the unit.

Unfortunately, mounting an expansion tank in this manner can add considerable weight to the supporting structures, in some cases compromising the integrity of both the rafter and the expansion tank itself.

### BRIEF DESCRIPTION OF THE DRAWINGS

FIG. 1 is a perspective view illustrating a support stand mounted on the top of a water heater, constructed in accordance with the present invention.

FIG. 2 is a perspective view illustrating a support stand mounted on the top of a water heater holding an expansion tank, constructed in accordance with the present invention.

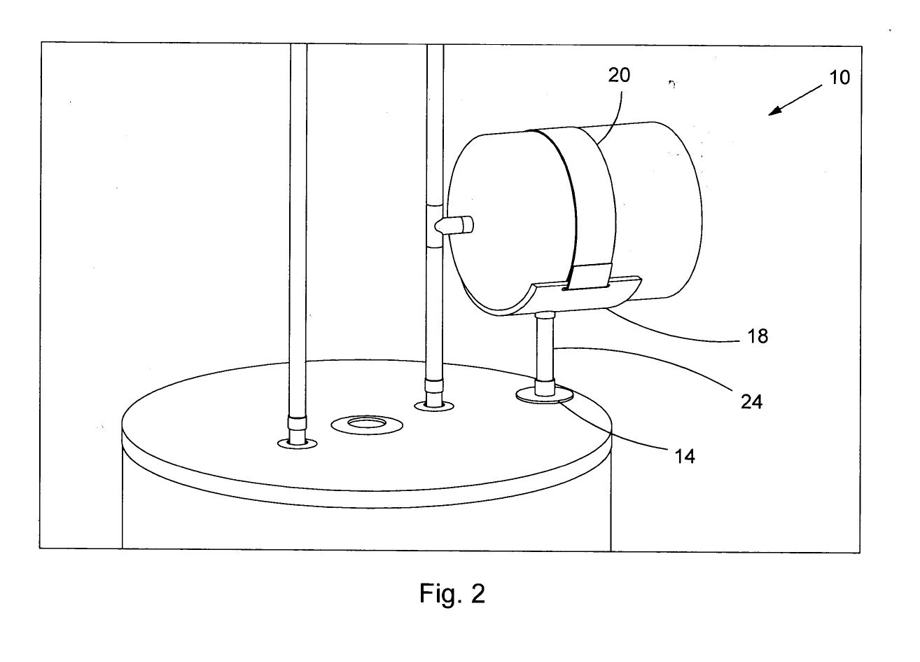

### DETAILED DESCRIPTION OF THE PREFERRED EMBODIMENTS

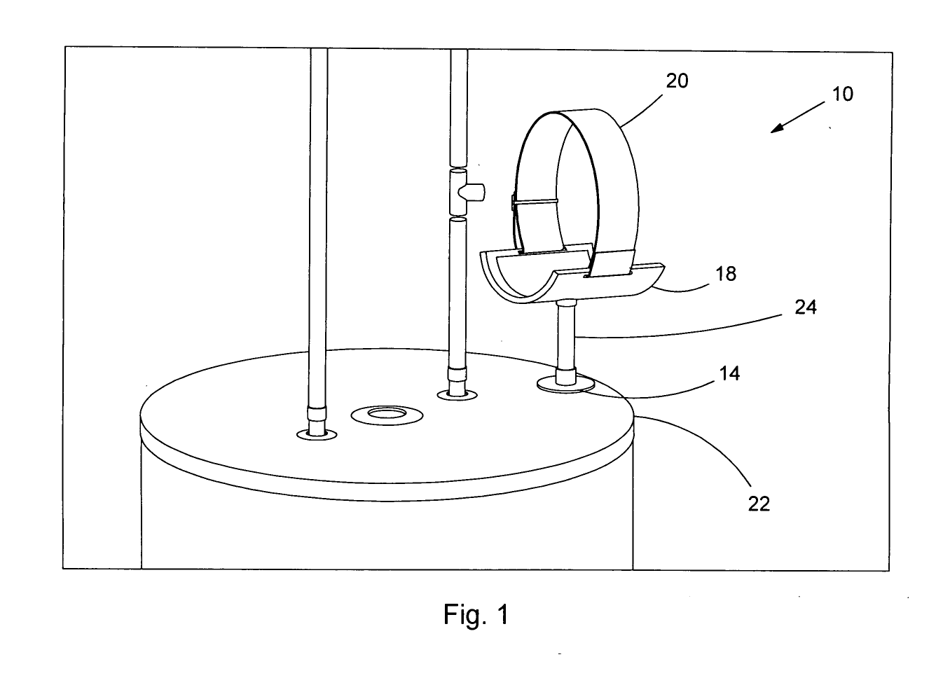

As illustrated in FIG. 1, the present invention is a support stand for an expansion tank that is mounted directly atop the hot water heater system, as opposed to suspended from the rafters.

The support stand 10 of the present invention is comprised primarily of heavy duty, non-corrosive PVC material and is offered in a variety of sizes to accommodate expansion tanks of various sizes and configurations. The stand 10 is mounted to the top of the water heater 22 by way of a sturdy base plate 14. A vertical support 24 manufactured of PVC extends from this base plate 14, with the top of this stand featuring a cradle-like tank holder 18 on or inside of which the actual expansion tank is mounted. The cradle-like tank holder has a curved bottom capable of receiving a cylindrical expansion tank, further wherein the cradle-like support has parallel sides. Further securing the expansion tank in place, a heavy duty strap 20 is affixed to each parallel side of the cradle-like tank holder. The straps run around the exposed perimeter of the tank, and can be secured to each other by means of a clamp or self-affixing hook and loop fastener, thus securing the tank and preventing the tank from shifting during use. In this manner, the weight of the expansion tank is fully supported by the support stand 10 and water heater, eliminating the need for overhead support. With the expansion tank properly installed within the stand, the tank functions in the same manner as any other expansion tank and accommodates the expansion of water from the hot water tank, as it is heated, thus protecting the external plumbing from excessive pressure build up.

The support stand of the present invention offers users a number of significant benefits and advantages. Foremost, the support stand provides a sturdier and more reliable means of supporting horizontal expansion tanks. A cleverly designed support stand that is mounted directly atop the hot water heater itself, the stand eliminates the need to secure the expansion tank directly to a home's rafters. As rafters offer structural support to ceilings and side walls, removing the heavy expansion tank from the rafters could effectively protect the integrity of these strikers. Offering a more secure means of supporting the weight of the tank, the stand effectively prevents the damage that can occur to plumbing and surrounding fixtures should the tank become loose or fall from the rafters during use. Aesthetically pleasing, the stand blends with the overall design of the water heater, resulting in a cleaner, unfettered look of the entire water heater system. Simple to install, professional plumbers will appreciate the ease of which this product could be employed.

The support stand of the present invention offers a stable and secure means of supporting water heater expansion tanks. Protecting the structural integrity of a home's rafters and the expansion tank itself, the support stand proves an invaluable commodity in any home where horizontal expansion tanks are utilized.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A support stand for an expansion tank comprising: a base plate capable of being mounted to a top of a water heater, a vertical support extending vertically from the base plate, a cradle-like tank holder mounted to the top of the vertical support, wherein the cradle-like tank holder has a curved bottom capable of receiving a cylindrical expansion tank, further wherein the cradle-like tank holder has parallel sides, and straps attached to the sides of the cradle-like holder, wherein the straps are capable of surrounding the perimeter of an expansion tank and securing the tank in the cradle-like holder, and further wherein the strap can be secured.

2. The support stand for an expansion tank of claim 1 wherein the straps are secured by means of hook and loop fasteners.

3. The support stand for an expansion tank of claim 1 wherein the straps are secured by means of a clamp.

4. The support stand for an expansion tank of claim 1 wherein the vertical support is manufactured of PVC.

5. The support stand for an expansion tank of claim 1 wherein the support stand is available in sizes to accommodate expansion tanks of various sizes and configurations.
